(19) United States
(12) Patent Application Publication
(10) Pub. No.: US 2023/0330941 A1
(43) Pub. Date: Oct. 19, 2023

(54) Method and Device for the Additive Manufacturing of a Workpiece

(71) Applicant: Carl Zeiss Industrielle Messtechnik GmbH, Oberkochen (DE)

(72) Inventors: Frank WIDULLE, Neu-Ulm (DE); Johann IRNSTETTER, Heidenheim an der Brenz (DE); Christian PLATT, Ulm (DE)

(21) Appl. No.: 18/340,268

(22) Filed: Jun. 23, 2023

Related U.S. Application Data
(63) Continuation of application No. PCT/EP2021/086035, filed on Dec. 15, 2021.

(30) Foreign Application Priority Data
Dec. 23, 2020 (DE) 10 2020 134 795.2

(51) Int. Cl. B29C 64/393; B29C 64/268; B29C 64/295

(52) U.S. Cl. CPC B29C 64/393; B29C 64/268; B29C 64/295; B33Y 10/00

(57) ABSTRACT

A method for additively manufacturing a workpiece includes obtaining a dataset that defines the workpiece in a layer stack. The method includes producing the layers in sequential production steps using a layer forming tool. At a defined point in time, the stack has an uppermost layer and zero or more layers underneath. The method includes thermally exciting the layer stack with a first pulsed thermal excitation. The first pulsed thermal excitation includes a spatially structured heating pattern that heats the uppermost workpiece layer in parallel at mutually spatially distant excitation points. The method includes recording images of the uppermost workpiece layer after the first pulsed thermal excitation and inspecting the layer stack using the images in order to obtain an inspection result. The inspection result is based on a time-based individual deformation profile or a time-based individual temperature profile determined from the images.

### CROSS-REFERENCE TO RELATED APPLICATIONS

This application is a continuation of PCT International Application No. PCT/EP2021/086035 filed Dec. 15, 2021, which claims priority to German Application No. 10 2020 134 795.2 filed Dec. 23, 2020. The entire disclosures of the above applications are incorporated by reference.

### FIELD

The present disclosure relates to methods and apparatus for additively manufacturing a workpiece. More particularly, the disclosure relates to methods and apparatus capable of inspecting workpiece layers of an additively manufactured workpiece during the sequential layer-by-layer manufacturing process.

### BACKGROUND

Additive methods for the manufacturing of workpieces are sometimes referred to as 3D printing. There are various additive manufacturing methods. In selective laser sintering (SLS) or selective laser melting (SLM), what is referred to as a powder bed made of a particulate material is used. Often the particulate material is a metallic material. However, there are also methods with particulate plastics materials, in particular polymers. Selected powder particles on the uppermost side of the powder bed are locally selectively melted or at least partially melted by means of a laser beam or electron beam and are in this way bonded to one another on cooling. A new layer of powder is then distributed over the workpiece structure and the unmelted residual powder, and a further workpiece layer is produced by means of the laser beam or electron beam. The workpiece is thus produced layer by layer in successive steps. As a rule, the individual workpiece layers are produced on a manufacturing platform from the bottom to the top, and after each workpiece layer the manufacturing platform is lowered by the layer height of the next layer.

The additive manufacturing of workpieces makes it possible to produce individual workpieces with a high degree of complexity and low material costs. At the same time, however, there are major challenges in terms of workpiece quality, since anomalies can occur in each individual material layer, which can lead to defects within the workpiece. Anomalies can result in defects, such as pores in the layer construction, micropores or porosity, local layer detachment/delamination, cracks inside and/or on the surface, dents, shape deviations, and/or material stresses. For this reason, there are numerous proposals for detecting defects in an additively manufactured workpiece if possible even during the manufacture of the layer sequence. US 2015/0061170A1, for example, discloses an optical measurement sensor with a camera that can be configured to enable a 3D coordinate measurement on the respectively uppermost material layer.

DE 10 2016 115 241 A1 discloses an additive manufacturing process that involves selectively heating a powder layer to form a solid workpiece layer. The workpiece layers produced are excited with ultrasonic energy waves using a wave generating laser. The propagating ultrasonic energy waves are detected and analyzed to determine physical properties of the workpiece layer. Further workpiece layers are produced in response to the information obtained.

DE 10 2017 108 874 A1 and US 2020/158499 A1, which have the same priority, disclose an optical system for generally enabling material testing with the aid of illumination from a plurality of different directions. In some variants, the system can be used to determine a height map of a material layer to be inspected.

DE 10 2017 124 100 A1 discloses a method and an apparatus for the additive manufacturing of workpieces, wherein an inspection by means of laser ultrasound is carried out during the manufacture. For the analysis, the result of the test is compared with the result of a simulation of the test.

U.S. Pat. No. 7,278,315 and EP 1 815 936 B1 each disclose laser-ultrasonic methods for detecting defects in an additively manufactured workpiece. In the method of EP 1 815 936 B 1, a grid-like pattern is heated on the workpiece surface. US 2007/0273952 A1 discloses a general method for analyzing thin surface layers with the aid of ultrasound. In this case, ultrasonic waves from distributed excitation points can be detected at a distant detection point.

DE 10 2016 110 266 A1 discloses a method and an apparatus for the additive manufacturing of workpieces, wherein laser ultrasonic measurements, absolutely measuring interferometry or laser pulse thermography are proposed for inspecting workpiece layers. In the latter case, thermal radiation emanating from the workpiece surface can be spectroscopically analyzed. DE 10 2016 110 266 A1 also mentions, as an inspection method, the measurement of the geometric shape and temperature of what is referred to as the melt pool.

DE 10 2014 212 246 B3 discloses thermal excitation of an additively manufactured workpiece during the manufacturing process in order to detect defects in the workpiece layers, wherein the thermal radiation from the uppermost workpiece layer is thermographically captured and analyzed.

DE 10 2016 201 289 A1 discloses a method for the additive manufacturing of a workpiece, wherein first measurement data are collected during the additive build-up using a thermographic material test or using an eddy current material test. After the additive build-up, second measurement data are collected by means of computed tomography and compared with the first measurement data. Results of the material test are to be classified using an algorithm, which is not described in more detail, from the field of supervised machine learning.

The publication “Review of in-situ process monitoring and in-situ metrology for metal additive manufacturing” by Everton et al., Materials and Design 95 (2016), 431-445, gives an overview of different methods for the inspection of additively manufactured workpieces using camera images and pyrometry.

DE 10 2008 030 691 A1 generally discloses an apparatus for materials testing by means of thermal radiation, wherein a test object to be tested is periodically heated and excited to self-emission of thermal radiation. A phase image of the object is created. This involves carrying out two or more measurement processes, each with different excitation frequencies, and the phase images obtained are subjected to differential processing.

U.S. Pat. No. 8,449,176 B2 discloses a further general method for processing thermographic data after thermal excitation of a test object. A variance is determined and compared with the variance of a sample of known quality in order to determine if the quality of the test object is acceptable.

DE 10 2019 112 757 A1 discloses a method and an apparatus for the additive manufacturing of a workpiece with a measurement device for determining individual properties of the layer stack. A structuring tool moves a first energy beam relative to the manufacturing platform to produce the workpiece layers. The measurement device includes an exciter that excites the layer stack with a second energy beam. The controller controls the second energy beam and/or the detection path for the measurement along a plurality of measurement trajectories, which can differ from the trajectories of the first energy beam.

### SUMMARY

Additively manufactured surfaces and thus the surface of each individual workpiece layer are typically very rough (in the range of a few μm rms) and produce strong reflections, at least when using metallic material particles. In addition, topographical reliefs are often produced, e.g. writing traces due to the laser process (chevron pattern) or patterns (e.g. chequerboard pattern) due to the scanning strategy. In addition, variations on the surface can occur during the process, such as balling or particle deposits. Overall, these effects, which can be in the range of several 100 μm, result in the inspection of the workpiece layers and in particular the detection of defects under the surface being very difficult. Due to the rough surface and the further surface variations, local temperature changes and deformations that are not caused by anomalies and defects in the workpiece can occur during thermal stimulation. The temperature changes and deformations on the rough surface are superimposed on signals from the workpiece layers underneath. A method of the type mentioned in the introductory portion, in which signals caused by the surface topography can be distinguished more reliably from anomaly signals from the workpiece layers, is therefore desirable.

Against this background, it is an object of the invention to provide an alternative method and apparatus for the additive manufacturing of workpieces with a high quality.

It is a further object to monitor the quality of material layers in an efficient manner close to the process in order to be able to early correct occurring or emerging layer defects.

It is yet another object to distinguish anomalies in the workpiece layers as reliably as possible from effects that can be caused by a rough but defect-free surface.

According to a first aspect, there is provided a method for additively manufacturing a workpiece, comprising the steps: obtaining a dataset that defines the workpiece in a plurality of workpiece layers arranged one on top of the other; producing the plurality of workpiece layers arranged one on top of the other in a plurality of sequential production steps using a layer forming tool which is controlled in dependence on the dataset, wherein the plurality of workpiece layers arranged one on top of the other form a layer stack which, at a defined point in time, has a respective uppermost workpiece layer and a number of workpiece layers underneath; thermally exciting the layer stack at the defined point in time with a first pulsed thermal excitation having a pulse duration of between 0.5 ms and 50 ms, the first pulsed thermal excitation comprising a first spatially structured heating pattern that heats the respective uppermost workpiece layer in parallel at a plurality of mutually spatially distant excitation points; recording a plurality of images of the respective uppermost workpiece layer after the first pulsed thermal excitation with an image recording rate of at least 1 kHz; and inspecting the layer stack using the plurality of images in order to obtain an inspection result that is representative of the workpiece, wherein at least one of an individual deformation profile over time or an individual temperature profile over time of the respective uppermost workpiece layer in response to the first pulsed thermal excitation is determined using the plurality of images, and wherein the inspection result is obtained as a function of the at least one of the individual deformation profile over time or the individual temperature profile over time.

According to another aspect, there is provided a method for additively manufacturing a workpiece, comprising the steps of: obtaining a dataset that defines the workpiece in a plurality of workpiece layers arranged one on top of the other; producing the plurality of workpiece layers arranged one on top of the other using a layer forming tool which is controlled in dependence on the dataset, wherein the plurality of workpiece layers arranged one on top of the other form a layer stack which, at a defined point in time, has a respective uppermost workpiece layer and a number of workpiece layers underneath; thermally exciting the layer stack at the defined point in time; recording a plurality of measurement signals from the respective uppermost workpiece layer after the thermal excitation; and inspecting the layer stack using the plurality of measurement signals in order to obtain an inspection result which is representative of the workpiece; wherein at least one of near-surface deformations of the layer stack or surface temperatures of the layer stack are determined, wherein the layer stack is excited with a first spatially structured heating pattern that heats the respective uppermost workpiece layer at a first plurality of spatially separate regions at the defined point in time, and wherein the inspection result is determined in dependence on the first spatially structured heating pattern.

According to yet another aspect, there is provided an apparatus for additively manufacturing a workpiece, comprising a memory configured for obtaining a dataset that defines the workpiece in a plurality of workpiece layers arranged one on top of the other, comprising a manufacturing platform, comprising a layer forming tool, comprising a heating tool, comprising a measurement device directed at the manufacturing platform, and comprising an evaluation and control unit that is configured to produce a plurality of workpiece layers arranged one on top of the other on the manufacturing platform using the layer forming tool and the dataset, wherein the plurality of workpiece layers arranged one on top of the other form a layer stack which, at a defined point in time, has a respective uppermost workpiece layer and a number of workpiece layers underneath, configured to use the heating tool in order to thermally excite the layer stack at the defined point in time with a first spatially structured heating pattern which heats the uppermost workpiece layer at a first plurality of spatially separate regions at the defined point in time, configured to record a plurality of measurement signals from the respective uppermost workpiece layer using the measurement device, the measurement signals representing at least one of near-surface deformations of the layer stack or surface temperatures of the layer stack, and configured to inspect the layer stack using the plurality of measurement signals to obtain an inspection result that is representative of the workpiece, wherein the evaluation and control unit is configured to determine the inspection result in dependence on the first spatially structured heating pattern

The new methods and the apparatus thus utilize a heating pattern for thermal excitation that heats the uppermost workpiece layer in parallel at a plurality of mutually spatially distant excitation points. Accordingly, the spatially separate regions are heated simultaneously or at least substantially simultaneously and with a time overlap with the aid of the structured heating pattern, while spatial intermediate regions between the excitation points remain unaffected. In the intermediate regions, therefore, significantly less heating energy from the outside is incident on the uppermost workpiece layer. In this context, substantially simultaneously or with a time overlap means that the mutually distant excitation points are supplied with heating energy from the outside within such a short time interval that the mutually spatially distant excitations can propagate in a temporally overlapping manner and thus in parallel from the uppermost workpiece layer into the layer stack.

The structured heating pattern thus generates not only one thermal excitation at a selected point of the uppermost workpiece layer at the defined point in time, but it generates a plurality of thermal excitations at mutually spatially distant excitation points that are distributed on the uppermost workpiece layer. While the heating energy at the excitation points is incident on the layer stack from the outside and propagates laterally and normally from each excitation point into the layer stack, the heating energy between the excitation points penetrates substantially laterally into the intermediate regions. As a result, the heating energy reaches the intermediate regions with a time delay that depends on the spatial distance from the neighboring excitation points.

Depending on the position of an excitation point relative to a defect in the layer stack, the heating energy reaches the defect either from a predominantly lateral direction or from a predominantly normal direction with reference to the surface of the uppermost workpiece layer. If one of the numerous excitation points lies above a defect, the heating energy reaches the defect predominantly from the normal direction. By contrast, if the defect lies in an intermediate region between a plurality of excitation points, the heating energy reaches the defect predominantly from lateral directions. The structured heating pattern with a plurality of spatially distributed excitation points therefore generates different signal responses that depend on the position and extent of a defect.

The structured heating pattern improves the lateral extent of the thermal excitation in the layer stack and increases the information density of the measurement signals. It therefore enables a more precise localization of defects in the upper layers of the layer stack as well as a more precise determination of cracks that can extend from the uppermost workpiece layer into the layer stack. Each defect delays the heat conduction and can therefore be advantageously analyzed using near-surface deformations of the layer stack and/or using a transient analysis of the surface temperatures of the layer stack.

Overall, the structured heating pattern thus ensures that a plurality of thermal excitations propagate parallel to each other from the surface of the uppermost workpiece layer into the layer stack at a defined point in time. The lateral diffusion of the thermal excitation is enhanced compared to a singular thermal excitation. This enables a more reliable and more precise detection and determination of defects in near-surface regions of the layer stack. This means that the quality of the material layers can be efficiently monitored as early as the manufacturing process. Occurring or emerging layer defects can be corrected at an early stage. The object mentioned above is therefore completely achieved.

In a preferred refinement of the invention, the uppermost workpiece layer at the defined point in time is further thermally excited with a second spatially structured heating pattern, wherein the first spatially structured heating pattern and the second spatially structured heating pattern differ from one another, and wherein the inspection result is determined in dependence on the first spatially structured heating pattern and in dependence on the second spatially structured heating pattern.

With this refinement, the information density of the measurement signals is increased even further. The refinement therefore enables better defect detection. The first and the second structured heating patterns may differ in one or more pattern parameters. For example, the spatial distribution of the parallel excitation points, the respective spatial distances between the excitation points, the number of parallel excitation points, and/or the respective spatial extent of the individual excitation points can differ from one another. In addition to this, further excitation parameters, such as an excitation intensity and/or an excitation duration, can be varied in order to further increase the information density of the measurement signals.

In a further refinement, the first spatially structured heating pattern is inverted and/or rotated about an axis transverse to the surface of the uppermost workpiece layer in order to produce the second spatially structured heating pattern.

This refinement enables a very rapid variation of the first structured heating pattern on the uppermost workpiece layer and thus a very simple and rapid change from the first structured heating pattern to the second structured heating pattern. In the case of a pure rotation, the second structured heating pattern can be, viewed in isolation, the same pattern as the first structured heating pattern. However, due to the rotation, the second structured heating pattern has a different relationship to the uppermost workpiece layer, and this different relationship distinguishes the second structured heating pattern from the first structured heating pattern.

In a further refinement, the first spatially structured heating pattern has a spatial periodicity along the uppermost workpiece layer.

In this refinement, the first spatially structured heating pattern, and advantageously also the second spatially structured heating pattern, has a periodicity in at least one direction that runs parallel to the surface of the uppermost workpiece layer. The period, i.e. the distance between the respective maxima or between the respective minima of the heating pattern in the at least one direction, defines the size of each detection cell, since the heating energy of each maximum of the heating pattern propagates laterally toward the respective minima of the heating pattern. The cell size preferably correlates with the lateral extent of the defects to be detected, with the result that in preferred example embodiments the period is selected in dependence on the expected defect size. In some example embodiments it is possible to vary the period from the first heating pattern to the second heating pattern to reliably detect defects with different lateral extents. The refinement has the further advantage that a variation of the first heating pattern can be achieved very easily and quickly by laterally shifting the heating pattern in the direction of the periodicity by a fraction of the period.

In a further refinement, the first spatially structured heating pattern has a matrix structure with a plurality of spaced-apart heating points which are distributed on the uppermost workpiece layer.

In this refinement, the spatially structured heating pattern defines a plurality of excitation points and intermediate regions distributed in two orthogonal spatial directions. The excitation points and intermediate regions can be distributed along rows and columns. In some example embodiments of this refinement, the spatially structured heating pattern can have a periodicity in two mutually orthogonal spatial directions. For example, the structured heating pattern can be a checkerboard pattern, a grid pattern, a hexagonal pattern, or the like. The refinement has the advantage that a plurality of detection cells are produced with a structured excitation. Any defects in the layer stack can be detected and localized with a high resolution.

In a further refinement, the measurement signals include a plurality of temporally successive images of the uppermost workpiece layer.

In this refinement, images of the uppermost workpiece layer are used to determine near-surface deformations of the layer stack and/or surface temperatures of the layer stack in response to the thermal excitation. Preferably, an image stack is recorded with a plurality of temporally successive images starting with the thermal excitation. In some example embodiments, the image stack may also include images of the uppermost workpiece layer during the thermal excitation and/or prior to the thermal excitation. The images of the image stack are preferably recorded with an image recording rate >1 kHz, with the result that the temporal resolution is in the millisecond or sub-millisecond range. In combination with a pulse-like thermal excitation with heating pulses with a pulse duration of between 0.5 ms and 50 ms, this refinement provides very good detection results. In general, the refinement has the advantage that a high information density can be captured and evaluated very quickly. In some example embodiments, the measurement device can include an infrared camera, which can advantageously record a temperature distribution on the surface of the uppermost workpiece layer. Alternatively or additionally, transient deformations on the surface of the uppermost workpiece layer can be determined two-dimensionally using the images.

In a further refinement, the inspection result is determined on the basis of the plurality of images using a principal component analysis.

A principal component analysis (PCA) is a mathematical method of statistics known per se. It is advantageously suitable for structuring and simplifying extensive datasets by approximating a plurality of statistical variables using a smaller number of linear combinations that include as much information as possible, the so-called principal components. The principal component analysis enables an analysis of many deformation profiles in a very advantageous and efficient way and is therefore particularly well suited when individual temporal deformation profiles are to be analyzed over many image segments and even at the pixel level. In some example embodiments, the characteristic features of each deformation profile or, alternatively, a polynomial or a rational function with up to 6 degrees of freedom can be used to model the temporal change in each deformation profile in logarithmic form. The coefficient images generated in this way can be converted into a smaller number of more compressed PCA coefficient images by means of principal component analysis. Cluster algorithms can then advantageously be applied to these compressed PCA coefficient images for segmentation purposes. In combination with a threshold value decision, an anomaly probability can then be determined in the respective segmented image regions in an efficient manner. The principal component analysis therefore enables a very efficient determination of the inspection result.

In a further refinement, the first spatially structured heating pattern is varied over time.

In this refinement, excitation parameters, such as excitation intensity (heating power) and/or excitation duration (pulse length of a heating pulse) are varied in order to obtain an even higher information density from the uppermost workpiece layer. In some example embodiments, a plurality of image stacks of the uppermost workpiece layer may be recorded after thermal excitation with the first heating pattern, with the excitation parameters being varied from one image stack to another. In some example embodiments, the thermal excitation can include a temporal amplitude modulation, which is advantageously evaluated in accordance with the lock-in thermography method.

In a further refinement, the first spatially structured heating pattern is produced with the aid of a heating laser and an optical element which is arranged in the beam path of the heating laser. The optical element may advantageously include a diffractive optical element and/or a computer-generated hologram.

In this refinement, the structured heating pattern can be produced very efficiently using a heating laser. In some example embodiments, a laser serving as a structuring tool to produce a workpiece layer can be used as a heating laser in a subsequent step, wherein the structured heating pattern is produced with the aid of the optical element, which is selectively inserted into the optical path of the laser. Such an implementation is possible in a very cost-effective and compact manner.

In a further refinement, the first spatially structured heating pattern is produced with the aid of a plurality of spatially distributed heating coils. In the case of metallic materials in particular, the uppermost workpiece layer can be inductively thermally excited very cost-effectively and efficiently using a plurality of heating coils. In some example embodiments, a matrix of spaced-apart heating coils can be moved relative to the uppermost workpiece layer.

In a further refinement, the first spatially structured heating pattern is produced with the aid of a scanning electron beam.

An electron beam can be moved very quickly with the aid of electromagnetic fields and can therefore be used advantageously to illuminate a plurality of excitation points on the uppermost workpiece layer with heating energy within a very short time interval. The refinement is particularly advantageous if the uppermost workpiece layer is also produced using the electron beam.

In a further refinement, an individual deformation profile over time and/or an individual temperature profile over time of the uppermost workpiece layer is determined in response to the thermal excitation. The individual deformation profile over time advantageously has a plurality of characteristic features, which include an individual increase in deformation, an individual maximum deformation and an individual deformation decrease, with the inspection result being determined using at least one of the characteristic features mentioned from the plurality of characteristic features, preferably using at least two of the characteristic features mentioned.

The method and the apparatus of this refinement primarily consider the temporal behavior of the layer stack in response to the thermal excitation. What is analyzed is not only whether or to what extent a deformation and/or a temperature increase of the layer stack becomes visible on the uppermost workpiece layer. Rather, the profile of the deformations over time and/or the temperature increase over a defined time interval at the beginning of and/or after the thermal excitation are also analyzed. As has been shown, near-surface defects in the layer stack can be detected hereby very reliably, even if the layer surface has a roughness and/or writing structures.

In a further refinement, the individual temporal deformation profile is determined using at least one of the following measurement methods: speckle interferometry, digital holography, shearography; laser Doppler vibrometry, Fabry-Perot interferometry, Sagnac interferometry, interferometry with nonlinear optics.

A surface measurement with interferometric accuracy can be performed in a speckle interferometer using coherent light, e.g. with an electronic speckle pattern interferometer (ESPI). ESPI is particularly advantageous for technical surfaces with roughnesses in the range of several μm rms. In addition, ESPI enables the measurement of deformations orthogonal to the surface (z-direction, “out-of-plane”) and also in the surface plane (x/y-direction, “in-plane”). For an area-based measurement in the kHz range that is fast in a process-adapted manner, it is advantageous to use an ESPI system with a spatial (rather than temporal) phase shift. If for application reasons the measured variables exceed the unambiguous range of the interferometer (due to a combination of heating parameters, frame rate, material), phase unwrapping algorithms can be applied to the measured values or two or more wavelengths can be used in the interferometer to increase the unambiguous range. The use of two different wavelengths or angles (observation or illumination direction) in the speckle interferometer allows the surface shape/topography to be measured.

In shearography, a shearing element (e.g. a wedge plate or a tilting mirror) is used in the optical beam path, as a result of which the surface to be measured is imaged on the camera sensor both directly and laterally offset at the same time. The measured variable here is the gradient of the deformation in the direction of the lateral image offset. As a result, the sensitivity is given fundamentally along a preferred lateral direction, which is why it is advantageous for capturing the overall deformation to carry out a further measurement in a further lateral direction (preferably orthogonal to the first).

Speckle interferometry and shearography have the advantage that the measurement results have a high lateral and axial resolution. They are therefore advantageous when the aim is to inspect large-are workpieces. In contrast to this, it is advantageous to combine laser Doppler vibrometry, Fabry-Perot interferometry, Sagnac interferometry or interferometry with non-linear optics with a scan of the workpiece surface in a lateral direction, i.e., to scan the workpiece surface. The methods mentioned have a high axial resolution and therefore enable a reliable detection of anomalies in the depth of the layer stack.

A vibrometer is commonly used for vibration analyses using the optical Doppler effect to measure surface velocities and/or displacements. Scanning systems (3D scanning vibrometers) or multipoint vibrometers are suitable for a spatially resolved measurement. A multipoint vibrometer is advantageous for an area-based measurement in the kHz range that is fast in a process-adapted manner in order to obtain a time-synchronous recording of all the measurement points on the surface.

All of the aforementioned methods enable a very detailed determination of thermally excited deformation profiles using the recorded images.

In a further refinement, the inspection result is furthermore determined using a thermal transient profile and/or using ultrasonic excitation and/or using a simulated deformation profile and/or using melt pool characterization and/or using angle-selective illumination of the uppermost workpiece layer.

In this refinement, the inspection based on thermally excited deformation transients is combined with other inspection methods which, taken individually, have already been proposed in the prior art mentioned in the introductory portion. The refinement enables an even more reliable detection of defects under the surface of the uppermost workpiece layer due to the information density which has been increased even further. The inspection methods that are known per se become even more effective in combination with the new method and the new apparatus.

It goes without saying that the aforementioned features and those yet to be explained below can be used not only in the combination specified in each case but also in other combinations or on their own, without departing from the scope of the present invention.

### BRIEF DESCRIPTION OF THE DRAWINGS

The present disclosure will become more fully understood from the detailed description and the accompanying drawings.

FIG. 1 is a schematic illustration of one example embodiment of the new apparatus.

FIG. 2 shows a few example deformation profiles to explain example embodiments of the new method.

FIG. 3 shows an example image of an uppermost workpiece layer to explain example embodiments of the new method.

FIGS. 4A and 4B show an example structured heating pattern and its inversion.

FIG. 5 shows a further structured heating pattern with different pattern variations.

FIG. 6 shows an example matrix-type arrangement of heating coils for producing a structured heating pattern.

FIG. 7 shows a flowchart to explain an example embodiment of the new method.

FIG. 8 shows a flowchart to explain the inspection of an uppermost workpiece layer in an example embodiment of the new method.

In the drawings, reference numbers may be reused to identify similar and/or identical elements.

### DETAILED DESCRIPTION

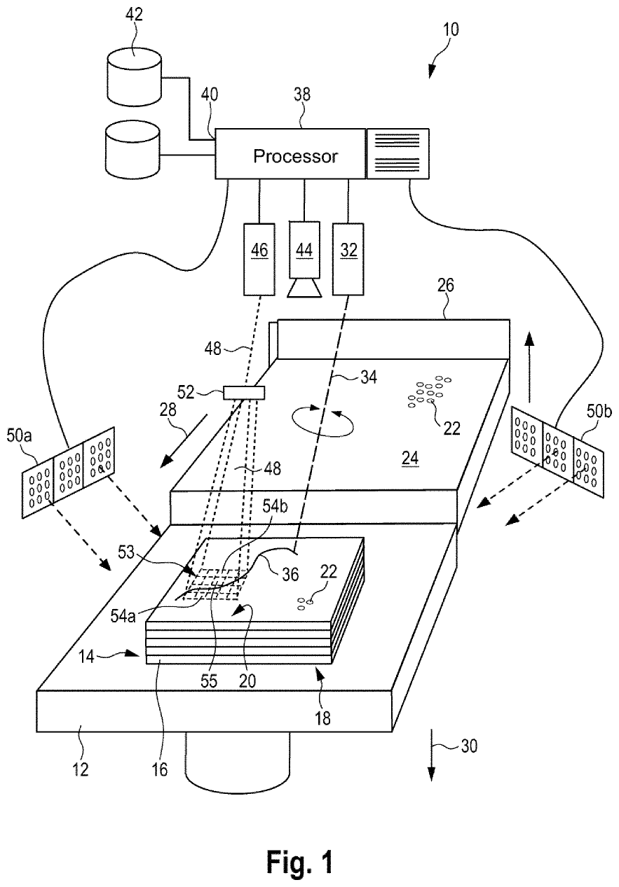

In FIG. 1, an example embodiment of the new apparatus is denoted in its entirety by reference number 10. The apparatus 10 has a manufacturing platform 12, on which a workpiece 14 is additively manufactured in accordance with an example embodiment of the new method. The workpiece 14 is built up layer by layer from the bottom to the top in temporally successive steps, that is to say with workpiece layers 16 arranged one above the other. The workpiece layers 16 form a layer stack 18, each with one respectively uppermost workpiece layer 20.

In the example embodiment illustrated here, the workpiece layers 16, 20 are each produced from a particulate material 22, in particular a metallic material and/or a plastics material in what is known as a powder bed. The particulate material 22 is taken from a reservoir 24 and distributed on an existing layer stack 18 with the aid of a doctor blade 26, which is movable in the direction of the arrow 28. For this purpose, the manufacturing platform 12 is typically lowered in the direction of the arrow 30 by the height of the next workpiece layer and/or the reservoir 24 is raised relative to the manufacturing platform 12.

Reference number 32 denotes a tool with which the particulate material 22 can be selectively solidified on the layer stack 18. In some example embodiments, the tool 32 includes a laser beam 34 and moves it along a trajectory 36 relative to the manufacturing platform 12 to produce a workpiece layer 18 from the particulate material 22. The material particles can be selectively melted and/or partially melted with the laser beam 34 so that they bond to one another and solidify on cooling. Such a manufacturing principle is known as selective laser melting (SLM) or selective laser sintering (SLS).

In other example embodiments, the layer forming tool 32 may generate an electron beam to produce a workpiece layer on the manufacturing platform 12. Furthermore, the apparatus 10 can include more than one layer forming tool 32, that is to say it can use for instance two or more laser and/or electron beams for producing workpiece layers. However, the new method and the new apparatus are not limited to such a manufacturing principle. Alternatively or additionally, the workpiece layers can be produced using other additive methods, for example using what is known as stereolithography or by selectively supplying and/or depositing material.

The layer forming tool 32, hereinafter referred to as the writing laser for the sake of simplicity, is connected to an evaluation and control unit, hereinafter referred to as a controller 38 for short, which controls the movement of the laser beam 34. The controller 38 has an interface 40 via which a dataset 42 can be read in, which dataset defines the workpiece 14 to be manufactured in a plurality of layers arranged one on top of the other. The controller 38 controls the movement of the laser beam 34 relative to the layer stack 18 in dependence on the dataset 42, wherein the laser beam 30 describes a trajectory 36 in each workpiece layer 16, 18 to be manufactured, which trajectory results from the dataset 42 in each case. In some example embodiments, the controller 38 is implemented with the aid of one or more commercially available personal computers running an operating system, such as Microsoft Windows, MacOS or Linux, and one or more control programs with which example embodiments of the new method are implemented. In some example embodiments, the controller 38 may be implemented as a soft PLC on a commercially available PC. Alternatively or additionally, the controller 38 may be implemented with the aid of dedicated control hardware with one or more ASICs, FPGAs, microcontrollers, microprocessors, or comparable logic circuits.

The apparatus 10 further has a measurement device that is configured to inspect the workpiece layers 16, 20. In some advantageous example embodiments, the measurement device can further be configured to inspect the respective uppermost material layer of the particulate material 22 on the layer stack 18 before the particulate material 22 is selectively solidified to form a new workpiece layer.

The measurement device includes here a camera 44 and a heating tool 46, each of which is connected to the controller 38 (or to a separate controller for the measurement device, not shown here). The camera 44 is configured to record a plurality of images of the respectively uppermost workpiece layer 20 of the layer stack 18. The heating tool 46 is configured to thermally excite the layer stack 18 at a defined point in time. In some example embodiments, the heating tool 46 generates a further laser beam 48, which illuminates the respective uppermost material layer 18 and heats up the layer stack 18 locally. Alternatively or additionally, the heating tool 46 can include an electron beam and/or thermally excite the layer stack 18 inductively with an energy pulse.

The thermal excitation increases the temperature at the excitation point on the surface of the layer stack 18. Due to the temperature gradient, the heat propagates from the excitation point laterally and normally to the layer surface into the volume of the layer stack. The material expands in the process. The stretching leads to local deformations in the layer stack and on its surface. The profile of the local deformations over space and time can be recorded with the measurement device. The measurement device can advantageously record the deformations with the aid of the camera 44 and interferometry. Accordingly, the camera 44 can be an integral part of an interferometric measurement system, in particular a speckle interferometer. Alternatively or additionally, the measurement device can implement shearography, laser vibrometry, Fabry-Perot interferometry, Sagnac interferometry and/or interferometry with non-linear optics. Alternatively or additionally, the camera 44 may include an infrared camera with which a spatial and temporal profile of the surface temperature of the layer stack 18 in response to the thermal excitation can be recorded in an image sequence.

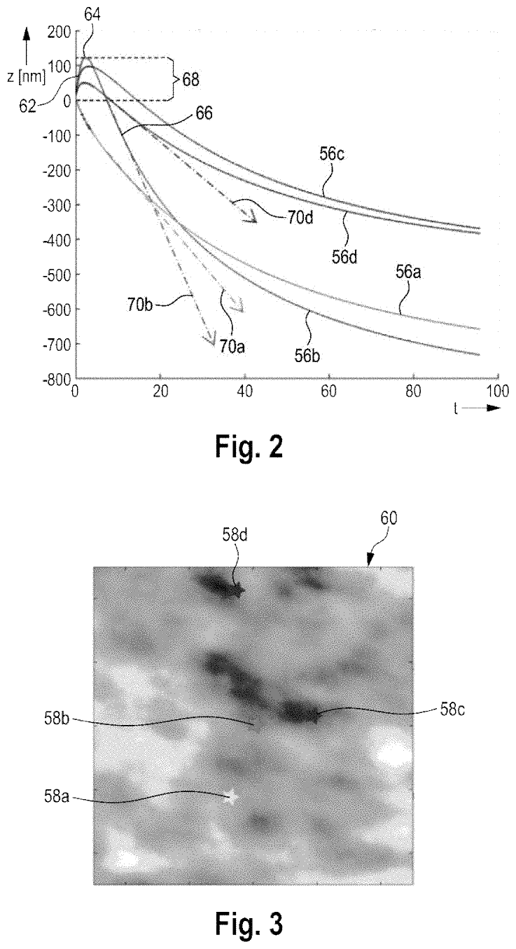

The deformations and temperature distributions in response to the thermal excitation depend on the material properties and also on the individual layer construction. Surface roughness and the trajectories 36 of the writing beam 34 can influence the individual layer construction. The measurement device with the camera 44 and the heating tool 46 is configured to detect the local deformations and/or the temperature distribution in the layer stack in response to the thermal excitation with both temporal and spatial resolution. In this example embodiment, the evaluation and control unit 38 is advantageously configured to analyze the transients of the deformation and/or temperature profile. If a locally varying behavior is detected here, conclusions can be drawn therefrom about the material properties and defects (anomalies) in the layer stack. Examples of such defects are blow-holes, porosity, unmelted particles, delamination, etc.; with varying porosity, for example, the heat conduction changes. The same applies to a crack in the layer stack. In the case of individual defects, such as blow-holes with an extent of several 100 μm in all three dimensions, a heat build-up together with the mechanical properties leads to a characteristic deformation profile over time, as is explained in more detail further below with reference to FIGS. 2 and 3.

In some example embodiments, the measurement device may include an illumination arrangement with a plurality of illumination modules 50a, 50b arranged at different positions relative to the manufacturing platform 12 in order to illuminate the surface of the layer stack 18 from a plurality of different directions. In combination with the camera 44, the illumination arrangement can advantageously be used to additionally inspect the surface of the layer stack 18 using a method as described in US 2020/158499 A1, which is incorporated herein by reference. In a particularly advantageous manner, the surface of the powder bed can be inspected with the aid of the illumination arrangement before the particles are selectively solidified, in order to detect the occurrence of anomalies early and to avoid them as far as possible.

The measurement device further includes here an optical element 52 which is arranged in the beam path of the heating laser beam 48. In some example embodiments, the optical element 52 can selectively be introduced into the beam path of the heating laser beam 48. In further example embodiments, an optical element 52 can selectively be introduced into the beam path of the writing laser 34 in order to use the writing laser beam 34 as an alternative or in addition to the heating laser beam 48. Here, the optical element 52 produces a spatially structured heating pattern 53, which simultaneously heats the uppermost workpiece layer 20 at a first plurality of spatially separate regions 54a, 54b. Between the spatially separate regions 54a, 54b, intermediate regions 55 remain at which the uppermost workpiece layer 20 is not heated or is at least significantly less heated than at the spatially distant excitation points 54a, 54b.

In some example embodiments, the optical element 52 may be a diffractive optical element (DOE) that imprints the heating pattern 53 on the heating laser beam 48. In further example embodiments, the optical element 52 may include a computer-generated hologram. In further example embodiments (not shown here), the heating pattern 53 may be produced using an electron beam which can be moved very quickly using electromagnetic fields in order to illuminate a plurality of spatially distant excitation points 54a, 54b with heating energy within a very short time interval. Alternatively or in addition, the uppermost workpiece layer 20 may be inductively heated in further example embodiments with a plurality of spatially distributed heating coils, the spatially distributed heating coils producing a heating pattern 53 with a plurality of spatially separate excitation points 54a, 54b (cf. FIG. 6).

FIG. 2 shows, by way of example, a plurality of individual temporal deformation profiles 56a, 56b, 56c, 56d, which were determined here at selected pixels 58a, 58b, 58c, 58d of an image stack recorded with the camera 44. The image stack includes a plurality of images 60, one of which is shown in FIG. 3 by way of example. The images 60 of the image stack each show the deformations on the surface of the uppermost workpiece layer after it has been thermally excited with the heating tool. In some example embodiments, the images 60 are recorded at a frame rate of 1 kHz or more. Accordingly, the deformation profiles 56a, 56b, 56c, 56d each have a temporal resolution of 1 ms or less here. The time t in ms is plotted on the abscissa in FIG. 2, wherein the thermal excitation takes place here with a heating pulse which lasted a few milliseconds, approximately 5 ms, and ended here at t=0. In other words, FIG. 3 shows different individual deformation profiles 56a, 56b, 56c, 56d from the moment the thermal excitation has been switched off at time t=0. A dimension z in nm in the axial direction, i.e., perpendicular to the surface of the uppermost workpiece layer 20, is given on the ordinate. The dimension z shows the deformations on the surface of the layer stack 18 perpendicular to the surface of the uppermost workpiece layer 20.

In this case, the deformation profile 56a is an example of a workpiece region (or a pixel 58a imaging this workpiece region) which includes neither a hidden anomaly nor a disturbing surface roughness. The deformation profile 56a here shows a continuously decreasing curve corresponding to the deformation that is continuously decreasing after the heating pulse has been switched off. In contrast, the deformation profile 56b initially has an individual deformation increase 62 up to an individual deformation maximum 64. Only after the individual deformation maximum 64 does the deformation profile 56b drop with an individual deformation decrease 66. What is known as overshoot 68, which is the difference between the individual deformation maximum 64 and the maximum of the deformation profile 56a here, is a characteristic feature of a cavity hidden under the workpiece surface, hence a defect, because the heat initially builds up above the cavity. The deformation profiles 56c and 56d are examples of workpiece regions without hidden anomalies, but with roughness signals from the workpiece surface. A certain overshoot can also be seen here, but it is less pronounced than in the case of the deformation profile 56b. In addition, the deformation decrease is in each case flatter than in the case of the deformation profile 56b, as can be seen from the tangents 70a, 70b, 70d drawn in dashed lines.

Accordingly, a plurality of characteristic features of a deformation profile over time indicate a defect in contrast to surface roughness effects. The characteristic features 62, 64, 66 enable detection of material anomalies and even their depth determination:

Firstly, the heat needs a short period of time to penetrate to the deeper-lying anomaly, to generate a heat build-up, and to cause an associated measurable surface deformation. Within this initial time window “onset time” during the thermal excitation, effects that are seen primarily are effects that manifest in the steepness of the deformation increase. A characteristic feature of an anomaly is the greater slope of the deformation profile 56f compared with the slope of the deformation profile 56e and of the deformation profile 56g.

Another distinguishing feature between roughness signals and an anomaly to be detected below the surface becomes visible at the moment the thermal excitation is switched off and afterward. The surrounding area outside the anomaly cools much faster than the region above it, which leads to elastic deflection, i.e., to a kind of additional deformation directly above the anomaly. This additional deformation (“overshoot”) after switching off the thermal excitation source can advantageously be used as a necessary criterion for an underlying anomaly.

Due to the built-up heat above the anomaly and the associated stronger overall deformation, a stronger elastic relaxation also takes place above the anomaly after switching off the thermal excitation and after the effect described in b) (“fall-off”).

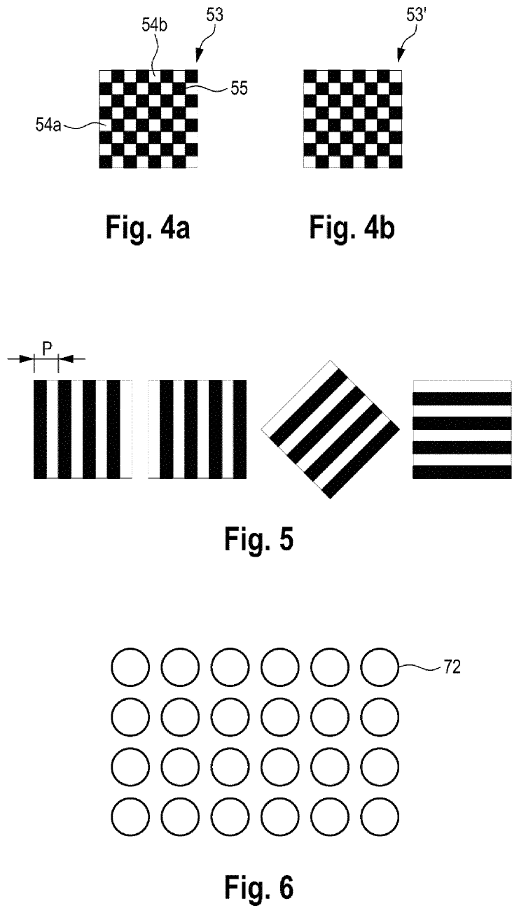

FIG. 4a shows an example first structured heating pattern 53 in the form of a checkerboard pattern. FIG. 4b shows an example second structured heating pattern 53′ that can be obtained by inverting the first heating pattern 53. The extent of the intermediate regions 55 (shown here as dark fields) between the excitation points 54a, 54b (shown here with white fields) preferably corresponds to the defect size to be detected. Accordingly, in some example embodiments, the size of the intermediate regions 55 between the excitation points 54a, 54b can be varied in temporal succession in order to obtain an optimal heating pattern 53, 53′ each for different defect sizes. For example, a thermal excitation with a heating power of ≥100 W per excitation point can take place, wherein the excitation points each have a diameter of between 1 mm and 100 mm and the excitation takes place with a heating pulse with a pulse duration of between 0.5 ms and 50 ms. These parameters may also be used independently of the checkerboard heating pattern shown here in conjunction with other heating patterns.

In some example embodiments, the inversion of the heating pattern 53 may take place by shifting the optical element 52. Alternatively or additionally, the optical element 52 may be rotated about an axis perpendicular to the uppermost workpiece layer (not shown here), as is shown in FIG. 5 using stripe patterns. Here, too, the period P of the stripe patterns preferably corresponds to the defect sizes that are to be expected or to be detected and can advantageously be in the range between 1 mm and 100 mm.

FIG. 6 shows a simplified illustration of a matrix arrangement of heating coils 72 with which the uppermost workpiece layer 20 can be inductively heated in some example embodiments.

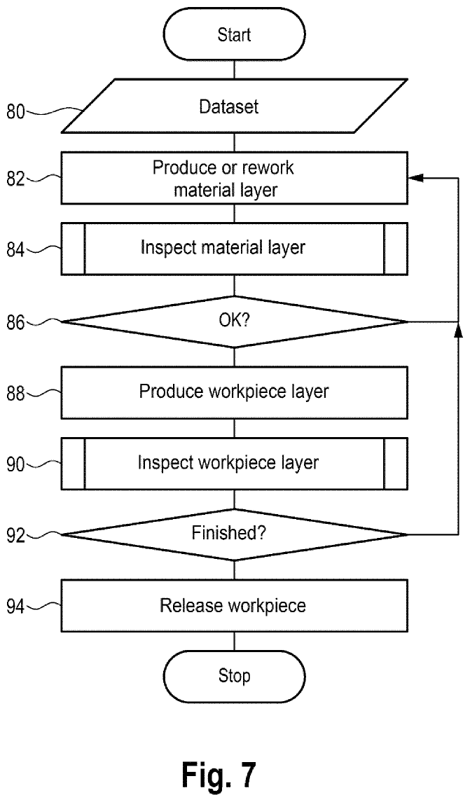

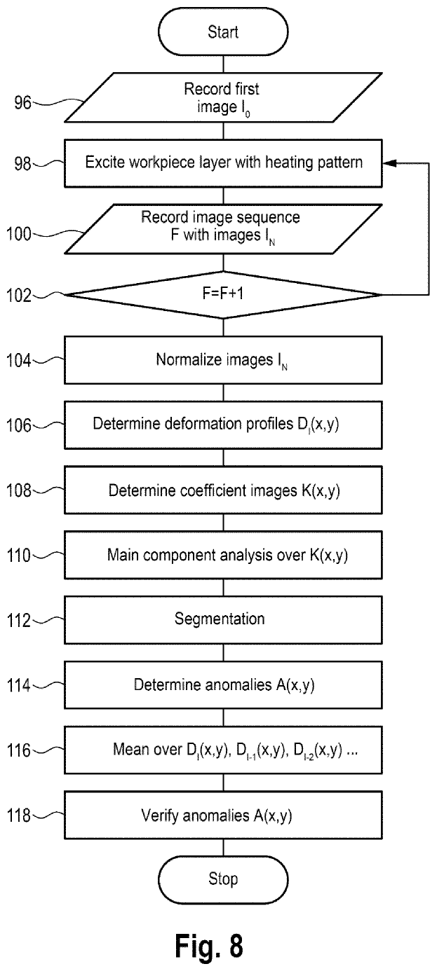

Exemplary embodiments of the new method, which can be implemented with the aid of one or more control programs on the apparatus according to FIG. 1, will be explained below with additional reference to FIGS. 7 and 8. According to step 80, a dataset 42 is read into the controller 38, which dataset defines the workpiece 14 in a plurality of workpiece layers 16, 20 arranged one on top of the other. As an alternative or in addition thereto, the controller 38 could first receive a dataset via the interface 40, which dataset defines the workpiece to be manufactured “as a whole,” such as a CAD dataset, and based on this, determine the plurality of workpiece layers 16, 20 arranged one on top of the other. In this case, too, the controller 38 ultimately obtains a dataset which defines the workpiece 14 in a plurality of workpiece layers 16, 20 arranged one on top of the other. According to step 82, a material layer made of particulate material 22 is produced on the layer stack 18 with the doctor blade 26.

According to step 84, the surface of the material layer is advantageously (but not absolutely necessary) inspected with the aid of the camera 44 and the illumination modules 50a, 50b in order to detect any anomalies, such as in particular grooves, holes, depressions, waves, accumulations of material, density variations, and/or particle inhomogeneities (e.g., lumps) in the material layer. If the surface of the material layer meets all the desired criteria, the method according to step 86 branches off to step 88, according to which an uppermost workpiece layer 20 is produced with the aid of the writing laser 32. The writing laser 32 selectively melts material particles along the defined trajectory 36 and in this way bonds the melted or partially melted particles to one another.

If the surface of the new material layer does not meet or does not sufficiently meet the desired criteria, the method can advantageously return to step 82 to rework or completely renew the surface of the material layer. According to step 90, an uppermost workpiece layer 20 that has been produced is inspected with the aid of the camera 44 and the heating tool 46, wherein the inspection based on the new method can also detect anomalies in the depth of the layer stack 18. Anomalies can also form later, for example due to stress cracks or later delamination between individual workpiece layers 16. In accordance with step 92, steps 82-90 are repeated until the workpiece 14 is completed in accordance with the dataset 42. If necessary, a subsequent workpiece layer can then be modified in order to correct a deviation in shape or size. According to step 94, the manufactured workpiece can be released for an intended use on the basis of the inspection results from the repeated steps 82 and/or 90.

FIG. 8 shows an example embodiment for the inspection of the workpiece layer 20 according to step 90 from FIG. 4. In step 96, a first image I₀ of the uppermost workpiece layer 20 is recorded before thermal excitation takes place in step 98. According to step 100, upon switching off (cf. FIG. 2) and/or at the start of the thermal excitation (cf. FIG. 4), an image sequence F with a plurality of temporally successive (staggered) images I_{N} is recorded. According to step 102, a decision is made as to whether a further image sequence F+1 should be recorded, wherein the thermal excitation in step 98 then preferably takes place with a different (second) heating pattern and/or a different intensity, a different duration and/or a different excitation point.

It is possible to take advantage of the fact that the characteristic transient features scale differently with the introduced heating energy, depending on whether they are caused by an anomaly-related heat build-up or by surface roughness. When comparing the coefficient images described below for different heating settings, the respective change or scaling behavior provides an additional distinguishing feature between a pure surface effect and an anomaly signature.

According to the optional step 104, the images I_{N} of all the image sequences F are advantageously normalized. For example, the image content of the first image I₀ can be subtracted from each picture I_{N} of the image sequence F to eliminate image background not caused by the thermal excitation. To correct for vibrations, in particular if there is little surrounding material or at edges, a zero-order or higher-order Legendre fit (or other polynomial fit) subtraction can advantageously be applied to each image of the image stack. In addition, a Legendre fit subtraction (or other polynomials) can be advantageously used to compensate for the effect of a spatially varying heating profile and/or to increase anomaly contrast. Furthermore, local frequency filters or Legendre fit subtractions can advantageously contribute to better distinguishing defects, since defects display a different deformation behavior than their surrounding area. The effects of a spatially slowly varying heating profile can therefore be distinguished from the local influences of the defects themselves.

According to step 106, a plurality of individual deformation profiles Di (x,y) are then determined for a plurality of pixels of the image sequences. According to step 108, coefficient images K(x,y) are determined using the individual deformation profiles Di (x,y). In one variant, the slope during the thermal excitation, the overshoot maximum height and/or its point in time and/or the fall-off deformation and/or any turning points in the deformation profiles can be determined pixel by pixel as coefficients. In another variant, the respective temporal change in the deformation profile can be determined pixel by pixel in linear or logarithmic form by a polynomial or by a rational function with a plurality of degrees of freedom, advantageously with 6 degrees of freedom. The coefficients of the polynomial or of the rational function then form the coefficients of the coefficient images K(x,y).

The entire information of the temporal profile with the abovementioned effects is then compressed in a few coefficient images K(x,y), which is advantageous with regard to storage requirements and data transmission. Using principal component analysis according to step 110, these coefficient images can be converted into a smaller number of more compressed PCA coefficient images. Cluster algorithms for segmentation purposes according to step 112 are advantageously applied here to this compressed form. In combination with a threshold value decision, an anomaly probability can then be determined in the respectively segmented image regions according to step 114. In order to obtain information about the depth of the anomaly, too, the point in time when a defect signature first occurs, i.e., the “onset time,” or the point in time of the maximum overshoot can be determined. Both signatures provide information about the relative depths of anomalies. For example, a relatively early overshoot maximum in a period of up to 10 ms after switching off the thermal excitation indicates an anomaly, while an overshoot maximum 20 ms after switching off the thermal excitation or even later indicates that the deformation profile was recorded at the periphery of a workpiece layer.

Another (optional) method for distinguishing between the effects of surface roughness and the effects induced by anomalies below the surface is the combining calculation of a plurality of measurement signals recorded at the same location but in successive layers, according to step 116. The respective layer surfaces of different layers vary and are often uncorrelated, whereas the anomalies below the surface persist and decrease only terms of in signal strength due to the increasing depth. If a weighted average is formed from N successive layer measurements at the same position, the surface signal is reduced by a factor of ˜(1/sqrt(N)) compared with the anomaly proportion.

According to step 118, additional information from other measurement methods can optionally be used to further increase the accuracy and reliability, in particular to improve the detection of anomalies and the separation of anomalies and surface effects and/or to increase the speed of the measurement method by preselecting regions (ROIs) and/or to better determine the spatial location (especially depth) and/or to classify it in terms of size and/or shape. In particular, further data from other measurement methods can be included in the analysis. These other measurement methods for a multimodal analysis that measure locally or cover the entire surface include measurement of the topography and determination of surface defects using the illumination modules 50a, 50b and a method as described in DE 10 2017 108 874 A1 and US 2020/158499 A1, which has the same priority, measurement of spatially resolved vibration distribution (vibrometry), determination of surface gradients and surface shape/topography by means of shearography, measurement of structure-borne sound (e.g., pulse-echo method with ultrasonic transducers and/or contactlessly with EMATs) on the base plate of the workpiece to be built up in layers, in particular for defect classification, measurement of properties of the temporary melt pool, e.g., average temperature radiation from the melt pool using a pyrometer or spatially resolved imaging of the melt pool by means of a camera in the VIS or IR spectrum, white light interferometry (WLI) to determine statistic sizes of the surface (e.g. roughness, power spectral density (PSD)), measurement methods to determine the temperature dependence of material constants (e.g., heat capacity, thermal expansion, thermal conduction, elastic moduli) in the process-relevant range (room temperature to melting temperature).

The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

1. A method for additively manufacturing a workpiece, the method comprising:
obtaining a dataset that defines the workpiece in a plurality of workpiece layers arranged one on top of another;
producing the plurality of workpiece layers arranged one on top of another in a plurality of sequential production steps using a layer forming tool controlled based on the dataset, wherein:
the plurality of workpiece layers arranged one on top of another form a layer stack, and
the layer stack, at a defined point in time, has a respective uppermost workpiece layer and a number of workpiece layers underneath;
thermally exciting the layer stack at the defined point in time with a first pulsed thermal excitation having a pulse duration of between 0.5 ms and 50 ms, wherein the first pulsed thermal excitation includes a first spatially structured heating pattern that heats the respective uppermost workpiece layer in parallel at a plurality of mutually spatially distant excitation points;
recording a plurality of images of the respective uppermost workpiece layer after the first pulsed thermal excitation with an image recording rate of at least 1 kHz; and
inspecting the layer stack using the plurality of images in order to obtain an inspection result that is representative of the workpiece,
wherein at least one of an individual deformation profile over time or an individual temperature profile over time of the respective uppermost workpiece layer in response to the first pulsed thermal excitation is determined using the plurality of images, and
wherein the inspection result is obtained as a function of the at least one of the individual deformation profile over time or the individual temperature profile over time.

2. The method of claim 1 wherein the respective uppermost workpiece layer is further thermally excited with a second spatially structured heating pattern, wherein the first spatially structured heating pattern and the second spatially structured heating pattern differ from one another, and wherein the inspection result is determined in dependence on both the first spatially structured heating pattern and in dependence on the second spatially structured heating pattern.

3. The method of claim 2 wherein the first spatially structured heating pattern is at least one of rotated or inverted in order to produce the second spatially structured heating pattern.

4. The method of claim 1 wherein the first spatially structured heating pattern has a spatial periodicity along the respective uppermost workpiece layer.

5. The method of claim 1 wherein the first spatially structured heating pattern has a matrix structure with a plurality of spaced-apart heating points distributed on the respective uppermost workpiece layer.

6. The method of claim 1 wherein the first spatially structured heating pattern is produced using a heating laser and an optical element arranged in a beam path of the heating laser.

7. The method of claim 1 wherein the first spatially structured heating pattern is produced using a plurality of spatially distributed heating coils.

8. The method of claim 1 wherein the first spatially structured heating pattern is produced using a scanning electron beam.

9. The method of claim 1 wherein the plurality of images are recorded using a camera that forms part of an interferometric measurement system.

10. The method of claim 1 wherein the plurality of images are recorded using an infrared camera.

11. A method for additively manufacturing a workpiece, the method comprising:
obtaining a dataset that defines the workpiece in a plurality of workpiece layers arranged one on top of another,
producing the plurality of workpiece layers arranged one on top of another using a layer forming tool which is controlled in dependence on the dataset, wherein the plurality of workpiece layers arranged one on top of another form a layer stack which, at a defined point in time, has a respective uppermost workpiece layer and a number of workpiece layers underneath,
thermally exciting the layer stack at the defined point in time,
recording a plurality of measurement signals from the respective uppermost workpiece layer after the thermal excitation, and
inspecting the layer stack using the plurality of measurement signals in order to obtain an inspection result which is representative of the workpiece,
wherein at least one of near-surface deformations of the layer stack or surface temperatures of the layer stack are determined,
wherein the layer stack is excited with a first spatially structured heating pattern that heats the respective uppermost workpiece layer at a first plurality of spatially separate regions at the defined point in time, and
wherein the inspection result is determined in dependence on the first spatially structured heating pattern.

12. The method of claim 11 wherein the respective uppermost workpiece layer is further thermally excited with a second spatially structured heating pattern, wherein the first spatially structured heating pattern and the second spatially structured heating pattern differ from one another, and wherein the inspection result is determined in dependence on both the first spatially structured heating pattern and in dependence on the second spatially structured heating pattern.

13. The method of claim 12 wherein the first spatially structured heating pattern is at least one of rotated or inverted in order to produce the second spatially structured heating pattern.

14. The method of claim 11 wherein the first spatially structured heating pattern has a spatial periodicity along the respective uppermost workpiece layer.

15. The method of claim 11 wherein the first spatially structured heating pattern has a matrix structure with a plurality of spaced-apart heating points distributed on the respective uppermost workpiece layer.

16. The method of claim 11 wherein the measurement signals include a plurality of temporally successive images of the uppermost workpiece layer.

17. The method of claim 16 wherein the plurality of images are recorded with an image recording rate ≥1 kHz, and wherein the layer stack is thermally excited with a pulse-shaped thermal excitation with a pulse duration of between 0.5 ms and 50 ms.

18. The method of claim 11 wherein the first spatially structured heating pattern is varied over time.

19. The method of claim 11 wherein at least one of an individual deformation profile over time or an individual temperature profile over time of the respective uppermost workpiece layer is determined in response to the thermal excitation.

20. An apparatus for additively manufacturing a workpiece, the apparatus comprising:
a memory configured to obtain a dataset that defines the workpiece in a plurality of workpiece layers arranged one on top of another;
a manufacturing platform;
a layer forming tool;
a heating tool;
a measurement device directed at the manufacturing platform; and
an evaluation and control unit configured to:
produce a plurality of workpiece layers arranged one on top of another on the manufacturing platform using the layer forming tool and the dataset, wherein the plurality of workpiece layers arranged one on top of another form a layer stack which, at a defined point in time, has a respective uppermost workpiece layer and a number of workpiece layers underneath,
use the heating tool in order to thermally excite the layer stack at the defined point in time with a first spatially structured heating pattern which heats the uppermost workpiece layer at a first plurality of spatially separate regions at the defined point in time,
record a plurality of measurement signals from the respective uppermost workpiece layer using the measurement device, the measurement signals representing at least one of near-surface deformations of the layer stack or surface temperatures of the layer stack, and
inspect the layer stack using the plurality of measurement signals to obtain an inspection result that is representative of the workpiece,
wherein the evaluation and control unit is configured to determine the inspection result in dependence on the first spatially structured heating pattern.
